(19) United States
(12) Patent Application Publication
(10) Pub. No.: US 2018/0089385 A1
(43) Pub. Date: Mar. 29, 2018

(54) PERSONALIZED TREATMENT MANAGEMENT SYSTEM

(71) Applicant: Praxify Technologies, Inc., Palo Alto, CA (US)

(72) Inventors: Abhijit Manohar Gupta, Pune (IN); Mohan Rao, Pune (IN)

(21) Appl. No.: 15/827,893

(22) Filed: Nov. 30, 2017

Related U.S. Application Data
(63) Continuation of application No. PCT/IN2016/000139, filed on May 30, 2016.

(30) Foreign Application Priority Data
May 30, 2015 (IN) 2107/MUM/2015

(51) Int. Cl. G06F 19/00

(52) U.S. Cl. CPC G06F 19/345; G06Q 50/22; G06F 19/325; G06F 19/322

(57) ABSTRACT

Methods, systems, and apparatus, including computer programs encoded on computer storage media for classification using neural networks. One method includes receiving captured patient data in a template format with one or more fields. Receiving a selection of a likelihood of an illness corresponding to a patient. Determining a treatment plan for the patient using captured patient data, wherein the treatment plan comprises content items with actionable tasks and interconnection between the content items that provide treatment steps based on the illness of the patient. Determining a workflow for the determined treatment plan for the patient.

### FIELD

This application is a continuation of and claims priority under 35 U.S.C. § 120 to PCT Application No. PCT/IN2016/000139, filed on May 30, 2016, which claims priority to an Indian Patent Application No. 2107/MUM/2015, filed on May 30, 2015, and each application is incorporated by reference in its entirety.

### BACKGROUND

Medical practice entails activities in relation to health and body, surgical procedures, examination procedures, diagnostic procedures, prognosis procedures, and the like activities. Qualified medical professional are equipped to deal with various facets of medical practice; in relation to the academic qualification that they have reached, in relation to the professional experience that they have gained.

However, a paper trail of documents can be found in in medical practice, which is cumbersome to doctors, to patients, and to the entire healthcare ecosystem. The paper trail is a deterrent for portability of information from one node of a healthcare environment to another. There needs to be coherence or collaboration for seamless access of data per patient.

Also, it has been found that some simple clinical protocols are not routinely followed in medical practice. It has been found that providing a nurse or other medical assistant with a checklist of recommended procedures can result in the attending physician being reminded in a timely manner regarding procedures that might have been overlooked.

### SUMMARY

The present disclosure relates to the field of information systems, computational systems, databases, networking systems, and communication systems.

In some implementations, the present disclosure relates to the field of healthcare information, healthcare technology, healthcare management, practice management, electronic medical records, and electronic health records. In particular, the present disclosure relates to a personalized treatment management system and method.

According to the present disclosure, a personalized treatment management system is provided to receive a treatment plan per illness per person with an ability to update itself based on at least a context or at least a weight in order to provide an updated context-aware personalized treatment plan.

In general, one innovative aspect of the subject matter described in this specification can be embodied in methods that include the actions of receiving captured patient data in a template format with one or more fields. Receiving a selection of a likelihood of an illness corresponding to a patient. Determining a treatment plan for the patient using captured patient data, wherein the treatment plan comprises content items with actionable tasks and interconnection between the content items that provide treatment steps based on the illness of the patient. Determining a workflow for the determined treatment plan for the patient.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination. In some implementations, the method includes, assigning weights to the illness based on pre-defined and self-learning rules utilizing a rule engine. Determining embedding rules utilized by the rule engine pertaining to a context item, wherein the context item comprises demographic, time, location, epidemic status, genomic data, patient history, and genetic sequence of the patient. The method can further include wherein the embedding rules comprise rules selected from a group of rules comprising contexts pertaining to illness data, data of the patient, historical data, empirical data, statistical data, third party data, medication data, and other data related to the patient.

The method can further include, in response to determining the treatment plan is not effective for curing the illness of the patient, determining a tweaked treatment plan to provide to the patient that comprises a symptoms checker and a measurements checker. The method can include wherein determining the tweaked treatment plan to provide to the patient further comprises: parsing data from the tweaked treatment plan to provide the actionable tasks to implement the tweaked treatment plan. Mapping the actionable tasks to one or more different tweaked treatment plan details. The method can further include wherein the actionable tasks comprise a measurement task type, a score task type, a wearable input task type, a reminder task type, booking task type, update symptoms task type, input task type, share task type, and a patient-specific task type. The method can further include receiving modifications to the workflow of the determined treatment plan using the predefined and self-learning rules of the rule engine. The method can further include determining whether values of the content items exist within an acceptable range, wherein the acceptable range changes based on a context weight applied to the workflow of the patient.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates a block diagram of the personalized treatment management system.

FIG. 2 illustrates another block diagram of the personalized treatment management system.

FIG. 3 illustrates a block diagram of the workflow management engine.

FIG. 4 illustrates a block diagram of the care coordination system.

Like reference numbers and designations in the various drawings indicate like elements.

### DETAILED DESCRIPTION

The terms medical record, health record, and medical chart are used somewhat interchangeably to describe the systematic documentation of a single patient's medical history and care across time within one particular health care provider and also with multiple health care providers.

Medical records comprise variety of notes and data relating to provider-patient interaction. This comprises diagnosis data, medical history data, signs and symptoms data, reports' data, test results' data, drugs and medication data, prognosis data, visit notes, insurance data, demographics, health histories, and the like. The maintenance of complete and accurate medical records is essential for the doctor as well as the patient from a medical perspective as well from a legal perspective.

Further, patient management systems (PMS) are referred to as programs or modules that are regulated as a medical device. It is a system that is used to acquire medical information from a medical device to be used in the treatment or diagnosis of a patient. It can also be used as an aid to supplement the judgement and decision of a doctor. It is also a system wherein data of a patient is captured at various stages and used for a variety of purposes.

The types of personal health information that can be included may be as follows: name, birth date, blood type, emergency contact, date of last physical, dates and results of tests and screenings, major illnesses and surgeries, with dates. In addition, the types of personal health information include a list of medicines, dosages and how long they are being taken; any allergies, any chronic diseases, and any history of illnesses in your family.

In an endeavor to promote paperless activities, legislations are now being passed. There are legislations in various parts of the world. One sector specific legislation in USA, is the HITECH Act, 2009. In USA, the Health Information Technology for Economic and Clinical Health Act, abbreviated HITECH Act, 2009, is aimed to promote and expand the adoption of health information technology. Its further aim is to create a nationwide network of electronic health records.

In order to conserve paper for a greener earth, electronic records have assumed great significance in today's world. The healthcare ecosystem, hence, warrants use of paperless systems and methods, which provide for medical records as well as for practice management.

Tablet computational devices along with smart phone or PDAs are omnipresent and this technology has seeped everyday life. It is important to leverage the ease and use of this technology in the healthcare ecosystem, too. Decreasing costs and increasing user acceptance are the key drivers of acceptance of this technology in everyday lives.

The term, ‘healthcare ecosystem’, or ‘healthcare’, generically refers to various personnel such as doctors, general practitioners, surgeons, specialist doctors, specialist surgeons, dentists, specialist dentists, physiotherapists, therapists, nurses, paramedical staff, nodes, systems, points of care, hospitals, clinics, dispensaries, nursing homes, imaging labs, diagnostic centres, test labs, testing labs, rehabilitation centres, operating rooms, recuperating centres, examination centres, chemists, pharmacies, ambulances, emergency units, and the like care-giving environments, and even insurance related practitioners and systems.

Electronic Medical Record refers to storing medical record in an electronic format as opposed to a paper format, which is widely practiced. The limitations of the paper format are its security, its portability, is universality.

In at least one embodiment, clinical protocol (or a medical guideline) is a document with the aim of guiding decisions and criteria regarding diagnosis, management, and treatment in specific areas of healthcare. Such documents have been in use for thousands of years during the entire history of medicine.

Evidence-based medicine (EBM) is a form of medicine that aims to optimize decision-making by emphasizing the use of evidence from well-designed and conducted research. Evidence-based medicine usually include summarized consensus statements on best practice in healthcare. A healthcare provider is obliged to know the medical guidelines of his or her profession, and has to decide whether or not to follow the recommendations of a guideline for an individual treatment.

Modern clinical protocols identify, summarize, and evaluate the highest quality evidence and most current data about prevention, diagnosis, prognosis, therapy including dosage of medications, risk/benefit and cost-effectiveness. Then they define the most important questions related to clinical practice and identify all possible decision options and their outcomes. Some guidelines contain decision or computation algorithms to be followed. Thus, they integrate the identified decision points and respective courses of action with the clinical judgment and experience of practitioners. Many guidelines place the treatment alternatives into classes to help providers in deciding which treatment to use.

Additional objectives of clinical protocols are to standardize medical care, to raise quality of care, to reduce several kinds of risk (to the patient, to the healthcare provider, to medical insurers and health plans), and to achieve the best balance between cost and medical parameters such as effectiveness, specificity, sensitivity, resoluteness, etc. It has been demonstrated repeatedly that the use of protocols by healthcare providers such as hospitals is an effective way of achieving the objectives listed above, although they are not the only ones.

However, during the course of practice, a healthcare provider realizes that there is no single or universal protocol that can be developed. Depending upon the provider's or doctor's practice, expertise, and experience, protocols have been and are continuously being developed on an ad-hoc basis. There is a need for a modular and customizable protocol generating mechanism which can be used as a central resource across healthcare providers or doctors. Moreover, this can provide for accountability at the provider end as well as at the receiver end, if developed and monitored correctly. Therefore, there is a need for a system which breaks down tasks of a protocol, feeds the tasks of the protocol to intended recipients, attracts feedback mechanisms, and therefore provides a check mechanism.

In some implementations, a personalized treatment management system is configured to receive a treatment plan per illness per person with an ability to update itself based on at least a context or at least a weight in order to provide an updated context-aware personalized treatment plan. The personalized treatment management system includes at least an illnesses' database adapted to comprise a list of illnesses for selection; at least a data capturing mechanism configured to capture data of a patient as per configured fields in a template; at least a treatment plans' database configured to comprise treatment plans corresponding to each selected illness, said treatment plan comprising content items with actionable tasks and interconnections between said content items to form an interconnection of content items providing treatment steps for an illness; at least a rule engine configured to determine rules, based on input, and self-learning mechanisms, for formulating said updated context-aware personalized treatment plan, which rules being selected from a group of rules consisting of rules relating to updating of content items, rules relating to addition of content items, rules relating to defining interconnections between content items, rules relating to updating interconnections between content items, rules relating to associating nodes per content item; at least a context determination mechanism configured to determine a context in order to provide a contextual bias to a treatment plan in order to effect change in rules of said rule engine, said at least a context determination mechanism being configured to provide a context input to said at least a rule engine; at least a workflow management engine configured to define a workflow per patient for selected treatment plans, said defined workflow further comprising content items, corresponding actionable tasks, corresponding interconnections, and corresponding nodes, said at least a workflow management being configured to provide a workflow-pertinent input to said at least a rule engine; at least a care coordination engine configured to prompt said content item, with said actionable task, to said associated node and further configured to communicably cooperate with a response collection mechanism, said response collection mechanism being further configured to identify a determination of a response from associated nodes of a treatment plan, said care coordination engine being further communicably coupled with said rule engine in order to change rules based on data from said response collection mechanism; at least a symptoms and measurements tracker configured to comprise at least a symptoms data input mechanism for receiving data items relating to symptoms or an actionable task, from an associated node, and further configured to comprise at least a measurements data input mechanism for receiving data items relating to measurements, from an associated node, each of said data items from said at least a symptoms data input mechanism and said at least a measurements data input mechanism being provided to said care coordination engine, said symptoms and measurements tracker being further communicably coupled with said rule engine in order to change rules; and at least a node definition mechanism configured to define at least a node governed by at least a node server, said at least a node server being communicably coupled, for transmitting and receiving data, with said at least a care coordination engine, said at least a response type framework, and said at least a symptoms and measurements tracker in order to configure rules of said at least a rule engine for provisioning an updated context-aware treatment plan through said at least a workflow management engine.

In some implementations, an illness database comprises a list of illnesses, each of said illnesses being configured with an identifier. The illness database comprising a list of illnesses, each of said illnesses comprising associated weights.

In some implementations, the personalized treatment management system comprises a dynamic weight assignment mechanism in order to assign weights to an illness based on pre-defined and self-learning rules.

In some implementations, the rule engine comprises embedded rules pertaining to a context item, said context item being demographic, time, location, epidemic status, genomic data of a patient, patient history, genetic sequence of a patient.

In some implementations, the personalized treatment management system comprises first populating mechanism, being activated in response to selection of an illness, in order to prompt further actions or populate further fields of said system.

In some implementations, data items in a treatment plan comprise procedure performed data items, further procedure data items, medications' data items, diet data items, nutrition data items, exercise data items, lab related data items, reports' data items, sleep related data items, vitals related data items, payments' data items, recommendations data items, referrals' data items, follow-ups' data items, notes' data items.

In some implementations, said actionable task is selected from a group of actionable tasks comprising a null value actionable task, an actionable task linked to a node defined within an environment and associated with a node server, an actionable task with a note to be read, an actionable task with a hyperlink, an actionable task with text content, an actionable task with a goal, an actionable task with a measurement, an actionable task with a score, an actionable task with multimedia content, an actionable task with summaries, an actionable task with descriptions.

In some implementations, said treatment plan being selected from a group of treatment plants consisting of doctor specific treatment plan, illness specific treatment plan, patient specific treatment plan, specialty specific illness treatment plan, and its combinations.

In some implementations, said updated context-aware treatment plan comprises at least a check identifier, said check identifier being at least a data item from said at least a symptoms and measurements checker.

In some implementations, said treatment plan comprises a variable content item specific to a patient depending upon pre-defined parameters derived from a context, said context being history of a patient, family history of a patient, demographics of a patient, lifestyle of a patient, genetic sequence of a patient, gene pool of a patient, genomic data of a patient, allergies of a patient, other external datasets pertaining to patient's location, digital phenotypic data, case studies, textbook matter, journal content, and such other patient-specific dynamics.

In some implementations, data from said data capturing mechanism is converted into content items which correlate with fields of said treatment plan.

In some implementations, said data capturing mechanism is configured to capture various other data items such as patient identification data items, patient demographic data items, illness grade data items, illness site data items, illness content data items, patient history data items, data items pertaining to illness data, genetic sequence data items, genomic data items, device related data items, implant related data items, data items related to patient's context, and data items essential for treating an illness, data items pertaining to maintaining a condition relating to an illness, in terms with said treatment plan.

In some implementations, data from said data capturing mechanism is used to assign or manage weights to rules of said at least a rule engine.

In some implementations, said rules are selected from a group of rules comprising contexts pertaining to illness data, patient data, historical data, empirical data, statistical data, third party data, medication data, and any other data related to patient's context.

In some implementations, said at least a workflow management engine comprises an editing mechanism configured to enable editing and learning of content items per treatment plan.

In some implementations, said at least a workflow management engine comprises a drag and drop mechanism configured to enable editing of interconnections of content items per treatment plan.

In some implementations, said system comprises a visit summary template configured to record data items associated with a visit between a patient and any of said nodes, said data items being content items correlative with said treatment plan.

In some implementations, said system comprises a visit summary template configured to record data items associated with a visit between a patient and any of said nodes, said data items being content items correlative with said treatment plan, characterized in that, said data items being used to assign or manage weights to rules of said at least a rule engine.

In some implementations, said system comprises at least an evidence based database configured to store content items relating to evidence based medicine, data from journals and clinical trials, case studies, and publications, and data from success and failure of other treatment plans, said content items being correlative with said treatment plan.

In some implementations, said system comprises at least an evidence based database configured to store content items relating to evidence based medicine, data from journals and clinical trials, case studies, and publications, and data from success and failure of other treatment plans, said content items being correlative with said treatment plan characterized in that, said content items being used to assign and manage weights to rules of said at least a rule engine.

In some implementations, said system comprises at least an evidence based database configured to store content items relating to evidence based medicine, data from journals and clinical trials, case studies, and publications, and data from success and failure of other treatment plans, said content items being correlative with said treatment plan characterized in that, said content items being correlated with at least one of data items selected from a group of data items consisting of illnesses' data items, medications' data items, data items pertaining to clinical data, data items pertaining to pathological data, data items pertaining to genomic data, data items pertaining to patient's context, data items pertaining to genetic data, time related data items, location related data items.

In some implementations, said care co-ordination engine is communicably coupled with a weight assignment mechanism configured to assign and manage weights to a defined actionable task or group of tasks.

In some implementations, said care co-ordination engine is communicably coupled with a weight assignment mechanism configured to assign or manage weights to a defined actionable task or group of tasks, characterized in that, a first rule engine is configured to define a first set of rules to determine or manage weights for an actionable task or group of tasks.

In some implementations, said care co-ordination engine is communicably coupled with a routing mechanism configured to route each divided task or group of tasks to a particular node using a node server.

In some implementations, said response collection mechanism comprises at least a response-type framework, which assigns what type of feedback is to be recorded.

In some implementations, said response collection mechanism comprises a second rule engine configured to define a second set of rules to determine the manner in which said response collection mechanism is to work.

In some implementations, said response collection mechanism comprises a second rule engine configured to define a second set of rules to determine the manner in which said response collection mechanism is to work, characterized in that, said second set of rules comprising parameters relating to the type and nature or task, rank and/or weight of task.

In some implementations, said response collection mechanism comprises a third rule engine configured to define a third set of rules to determine to which node said actionable task is to be routed.

In some implementations, said response collection mechanism comprises a third rule engine configured to define a third set of rules to determine to which node said actionable task is to be routed, characterized in that, said third set of rules comprising parameters template data and metadata.

In some implementations, said actionable tasks comprise notifications and follow-ups.

In some implementations, said care coordination engine is configured to provide simple feedback in terms of whether treatment plans or changes in treatment plans or portions of treatment plans have worked or need further change.

In some implementations, said care coordination engine further comprises a Natural Language Processing engine configured to parse data from said treatment plan in order to provide actionable tasks.

In some implementations, said care coordination engine further comprising a Natural Language Processing engine configured to parse data from said updated context-aware treatment plan in order to provide actionable tasks.

In some implementations, said care coordination engine further comprises a machine learning framework configured to learn from said updated context-aware personalized treatment plan in order to train itself.

In some implementations, said actionable tasks is selected from a group of tasks consisting of measurement task type, score task type, wearable input task type, reminder task type, booking task type, update symptoms task type, input task type, share task type, and any definable patient-specific task type.

In some implementations, said workflow management engine is configured to output treatment plan and nodes associated with said treatment plan.

In some implementations, said symptoms and measurements tracker comprises fields for receiving data items relating to symptoms and patient's context and fields for receiving data items relating to measurements, each of the data items being received as system input, user input, doctor input, patient input, or a node input.

In some implementations, said symptoms and measurements tracker comprises fields for receiving data items relating to symptoms and patient's context and fields for receiving data items relating to measurements, each of said fields being communicably coupled with at least a pre-configured comparator to check if said data item input is within an acceptable range.

In some implementations, said symptoms and measurements tracker comprises fields for receiving data items relating to symptoms and patient's context and fields for receiving data items relating to measurements, each of said fields being communicably coupled with at least a pre-configured comparator to check if said data item input is within an acceptable range, characterized in that, said range being a user-defined range.

In some implementations, said symptoms and measurements tracker comprises fields for receiving data items relating to symptoms and patient's context and fields for receiving data items relating to measurements, each of said fields being communicably coupled with at least a pre-configured comparator to check if said data item input is within an acceptable range, characterized in that, said range being a system-defined range.

In some implementations, said symptoms and measurements tracker comprises fields for receiving data items relating to symptoms and patient's context and fields for receiving data items relating to measurements, each of said fields being communicably coupled with at least a pre-configured comparator to check if said data item input is within an acceptable range, characterized in that, said range being a context-aware-defined range.

In some implementations, said symptoms and measurements tracker comprises fields for receiving data items relating to symptoms and patient's context and fields for receiving data items relating to measurements, each of said fields being communicably coupled with at least a pre-configured comparator to check if said data item input is within an acceptable range, characterized in that, said range being a personalized range.

In some implementations, said symptoms and measurements tracker is configured to receive outputs pertaining to measurements from a lab node, a wearable device node, and a diagnostics node.

In some implementations, said symptoms and measurements tracker is configured to receive outputs pertaining to symptoms from a patient node and a care giver node.

In some implementations, said symptoms and measurements tracker is configured to receive outputs pertaining to symptoms from a patient node and a care giver node, characterized in that, said outputs being weighted scores.

In some implementations, said symptoms and measurements tracker is configured to receive outputs pertaining to symptoms from a patient node and a care giver node, characterized in that, said outputs being context-aware weighted scores.

In some implementations, said determined context is used in weight assignment or management for a contextual bias so as to perform a function selected from a group of functions consisting of change ranges for symptoms and measurements tracker, change selectable inputs for symptoms and measurements tracker, change associated content items, change actionable tasks associated.

In some implementations, said system comprises at least a content item database to store content items. The system comprises at least an interconnection database to store interconnection relationships between content items.

In some implementations, said determined context is used to derive at least a parameter, said parameter being configured to change data of content item. In addition, said determined context is used derive at least a parameter, said parameter being configured to change or manage weight of an actionable task.

In some implementations, said determined context is used to derive at least a parameter, said parameter being configured to change or manage weight of an actionable task interconnections between content items.

In some implementations, said determined context is used to derive at least a parameter, each of said derived parameters being used by at least a mapping mechanism to map the parameters to an actionable task.

In some implementations, said determined context is used to derive at least a parameter, each of said derived parameters being used by at least a mapping mechanism to map the parameters to a node.

In some implementations, said determined context is used to derive at least a parameter, each of said derived parameters being used by at least a mapping mechanism to map the parameters to an actionable task, said actionable task being selected from a group of actionable tasks, which is pre-populated in said system, said group comprising: A) pre-instructed comparators configured or learnt to conduct comparisons to check output correlative to a currently replaceable content item with a predictive output of a replacement content item along with output data from corresponding systems and measurements tracker so as to determine if the replacement content item if substituted in the treatment plan provides for an acceptable output data from the corresponding systems and measurements tracker. B) Pre-instructed comparators configured or learnt to comparisons to check output correlative to a currently replaceable interconnection with a predictive output of a replacement interconnection along with output data from corresponding systems and measurements tracker so as to determine if the replacement interconnection if substituted in the treatment plan provides for an acceptable output data from the corresponding systems and measurements tracker.

In some implementations, said determined context is used to derive at least a parameter, each of said derived parameters being used by at least a mapping mechanism to map the parameters to an actionable task, each of the at least a derived parameter comprises a weight and an actionable task associated with it, which actionable task selected from a group of actionable tasks, said group comprising: a) updating of content items from a content item database, based on the parameter and associated weight; b) addition of content items from a content item database, based on the parameter and associated weight; c) defining interconnections between content items from an interconnection database, based on the parameter and associated weight; d) updating interconnections between content items from an interconnection database, based on the parameter and associated weight.

In some implementations, said nodes are distributed in a connected environment, with said node server communicating with each of nodes.

In some implementations, said nodes are distributed in a connected environment, with said node server communicating with each of nodes, characterized in that, some nodes being fitted with a compulsory feedback mechanism such that a user at that node is required to provide a feedback in response to a task assigned to said node.

In some implementations, said nodes are distributed in a connected environment, with said node server communicating with each of nodes, characterized in that, some nodes being fitted with a compulsory feedback mechanism such that a user at that node is required to provide a feedback in response to a task assigned to said node, characterized in that, said compulsory feedback mechanism being a time constrained mechanism.

In some implementations, said nodes are distributed in a connected environment, with said node server communicating with each of nodes, characterized in that, some nodes being fitted with a compulsory feedback mechanism such that a user at that node is required to provide a feedback in response to a task assigned to said node, characterized in that, said compulsory feedback mechanism being communicably coupled with said symptoms and measurement tracker in order to derive feedback.

In some implementations, said nodes are distributed in a connected environment, with said node server communicating with each of nodes, characterized in that, some nodes being fitted with a voluntary feedback mechanism such that a user at that node may record a feedback in response to a task assigned to the node.

In some implementations, said nodes are distributed in a connected environment, with said node server communicating with each of nodes, characterized in that, some nodes being fitted with a voluntary feedback mechanism such that a user at that node is required to provide a feedback in response to a task assigned to said node, characterized in that, said voluntary feedback mechanism being a time-constrained mechanism.

In some implementations, said nodes are distributed in a connected environment, with said node server communicating with each of nodes, characterized in that, some nodes being fitted with a voluntary feedback mechanism such that a user at that node is required to provide a feedback in response to a task assigned to said node, characterized in that, said voluntary feedback mechanism being communicably coupled with said symptoms and measurement tracker in order to derive feedback.

In some implementations, a personalized treatment management method is configured to receive a treatment plan per illness per person with an ability to update itself based on at least a context or at least a weight in order to provide an updated context-aware personalized treatment plan, said method comprising the steps of: storing a list of illnesses for selection; capturing data of a patient as per configured fields in a template; providing treatment plans corresponding to each selected illness, said treatment plan comprising content items with actionable tasks and interconnections between said content items to form an interconnection of content items providing treatment steps for an illness; determining rules, based on input, and self-learning mechanisms, for formulating said updated context-aware personalized treatment plan, which rules being selected from a group of rules consisting of rules relating to updating of content items, rules relating to addition of content items, rules relating to defining interconnections between content items, rules relating to updating interconnections between content items, rules relating to associating nodes per content item; determining a context in order to provide a contextual bias to a treatment plan in order to effect change in rules of said rule engine, said at least a context determination mechanism being configured to provide a context input to said rules; defining a workflow per patient for selected treatment plans, said defined workflow further comprising content items, corresponding actionable tasks, corresponding interconnections, and corresponding nodes, said at least a workflow management being configured to provide a workflow-pertinent input to said rules; prompting said content item, with said actionable task, to said associated node and further identifying a determination of a response from associated nodes of a treatment plan in order to change rules; receiving data items relating to symptoms or an actionable task, from an associated node, and receiving data items relating to measurements, from an associated node, each of said data items in order to determine prompting of said content item, and in order to change rules; and defining at least a node, for transmitting and receiving data, in relation with prompting said content item, prompting a response, prompting symptoms feedback, prompting content feedback in order to configure rules for provisioning an updated context-aware treatment plan.

In some implementations, said step of storing an illness comprises a step of configuring each of said illnesses with an identifier.

In some implementations, said method comprises a step of associating weights to each illness. The step of associating weights to each illness is based on pre-defined rules and self-learning rules. The step of determining rules comprises a step of embedding rules pertaining to a context item, said context item being demographic, time, location, epidemic status, genomic data of a patient, patient history, genetic sequence of a patient.

In some implementations, said method comprises a step of populating further fields of this method, in response to selection of an illness, in order to prompt further actions.

In some implementations, data items in a treatment plan comprise procedure performed data items, further procedure data items, medications' data items, diet data items, nutrition data items, exercise data items, lab related data items, reports' data items, sleep related data items, vitals related data items, payments' data items, recommendations data items, referrals' data items, follow-ups' data items, notes' data items.

In some implementations, said actionable task is selected from a group of actionable tasks comprising a null value actionable task, an actionable task linked to a node defined within an environment and associated with a node server, an actionable task with a note to be read, an actionable task with a hyperlink, an actionable task with text content, an actionable task with a goal, an actionable task with a measurement, an actionable task with a score, .an actionable task with multimedia content, an actionable task with summaries, an actionable task with descriptions.

In some implementations, said treatment plan is selected from a group of treatment plants consisting of doctor specific treatment plan, illness specific treatment plan, patient specific treatment plan, specialty specific illness treatment plan, and its combinations.

In some implementations, said updated context-aware treatment plan comprises at least a check identifier, said check identifier being at least a data item from said at least a symptoms and measurements checker.

In some implementations, said treatment plan comprises a variable content item specific to a patient depending upon pre-defined parameters derived from a context, said context being history of a patient, family history of a patient, demographics of a patient, lifestyle of a patient, genetic sequence of a patient, gene pool of a patient, genomic data of a patient, allergies of a patient, other external datasets pertaining to patient's location, digital phenotypic data, case studies, textbook matter, journal content, and such other patient-specific dynamics.

In some implementations, said step of data capturing comprises a further step of converting said data into content items which correlate with fields of said treatment plan.

In some implementations, said step of data capturing comprises a further step of capturing various other data items such as patient identification data items, patient demographic data items, illness grade data items, illness site data items, illness content data items, patient history data items, data items pertaining to illness data, genetic sequence data items, genomic data items, device related data items, implant related data items, data items related to patient's context, and data items essential for treating an illness, data items pertaining to maintaining a condition relating to an illness, in terms with said treatment plan.

In some implementations, said step of data capturing comprises a further step of assigning or managing weights to said rules.

In some implementations, said rules are selected from a group of rules comprising contexts pertaining to illness data, patient data, historical data, empirical data, statistical data, third party data, medication data, and any other data related to patient's context.

In some implementations, said step of defining a workflow per treatment plan comprises a further step of enabling editing and learning of content items per treatment plan.

In some implementations, said step of defining a workflow per treatment plan comprises a further step of enabling editing of interconnections of content items per treatment plan.

In some implementations, said method comprises a step of recording data items associated with a visit between a patient and any of said nodes, said data items being content items correlative with said treatment plan.

In some implementations, said method comprises a step of recording data items associated with a visit between a patient and any of said nodes, said data items being content items correlative with said treatment plan, characterized in that, said data items being used to assign or manage weights to rules of said at least a rule engine.

In some implementations, said method comprises at least a step of storing content items relating to evidence based medicine, data from journals and clinical trials, case studies, and publications, and data from success and failure of other treatment plans, said content items being correlative with said treatment plan.

In some implementations, said method comprises at least a step of storing content items relating to evidence based medicine, data from journals and clinical trials, case studies, and publications, and data from success and failure of other treatment plans, said content items being correlative with said treatment plan characterized in that, said content items being used to assign and manage weights to rules of said at least a rule engine.

In some implementations, said method comprises at least a step of storing content items relating to evidence based medicine, data from journals and clinical trials, case studies, and publications, and data from success and failure of other treatment plans, said content items being correlative with said treatment plan characterized in that, said content items being correlated with at least one of data items selected from a group of data items consisting of illnesses' data items, medications' data items, data items pertaining to clinical data, data items pertaining to pathological data, data items pertaining to genomic data, data items pertaining to patient's context data items pertaining to genetic data, time related data items, location related data items.

In some implementations, said step of prompting said content item, with said actionable task, to said associated node and further identifying a determination of a response from associated nodes of a treatment plan in order to change rules further comprises a step of assigning or managing weights to a defined actionable task or group of tasks.

In some implementations, said step of prompting said content item, with said actionable task or group of tasks, to said associated node and further identifying a determination of a response from associated nodes of a treatment plan in order to change rules further comprises a step of defining a first set of rules to determine or manage weights for an actionable task or group of tasks.

In some implementations, said step of prompting said content item, with said actionable task, to said associated node and further identifying a determination of a response from associated nodes of a treatment plan in order to change rules further comprises a step of routing each divided task or group of tasks to a particular node using a node server.

In some implementations, said step of prompting said content item, with said actionable task, to said associated node and further identifying a determination of a response from associated nodes of a treatment plan in order to change rules further comprises a step of assigning what type of feedback is to be recorded.

In some implementations, said response collection mechanism further comprises a step of defining a second set of rules to determine the manner in which said response collection mechanism is to work.

In some implementations, said step of prompting said content item, with said actionable task, to said associated node and further identifying a determination of a response from associated nodes of a treatment plan in order to change rules further comprises a step of defining a second set of rules to determine the manner in which said response collection mechanism is to work, characterized in that, said second set of rules comprising parameters relating to the type and nature or task, rank and/or weight of task.

In some implementations, said step of prompting said content item, with said actionable task, to said associated node and further identifying a determination of a response from associated nodes of a treatment plan in order to change rules further comprises a step of defining a third set of rules to determine to which node said actionable task is to be routed.

In some implementations, said step of prompting said content item, with said actionable task, to said associated node and further identifying a determination of a response from associated nodes of a treatment plan in order to change rules further comprises a step of defining a third set of rules to determine to which node said actionable task is to be routed, characterized in that, said third set of rules comprising parameters template data and metadata.

In some implementations, said actionable tasks comprise notifications and follow-ups.

In some implementations, said step of prompting said content item, with said actionable task, to said associated node and further identifying a determination of a response from associated nodes of a treatment plan in order to change rules further comprises a step of providing simple feedback in terms of whether treatment plans or changes in treatment plans or portions of treatment plans have worked or need further change.

In some implementations, said step of prompting said content item, with said actionable task, to said associated node and further identifying a determination of a response from associated nodes of a treatment plan in order to change rules further comprises a step of parsing data from said treatment plan in order to provide actionable tasks.

In some implementations, said step of prompting said content item, with said actionable task, to said associated node and further identifying a determination of a response from associated nodes of a treatment plan in order to change rules further comprises a step of parsing data from said updated context-aware treatment plan in order to provide actionable tasks.

In some implementations, said step of prompting said content item, with said actionable task comprises a further step of providing a machine learning framework configured to learn from said updated context-aware personalized treatment plan in order to train itself.

In some implementations, said actionable tasks is selected from a group of tasks consisting of measurement task type, score task type, wearable input task type, reminder task type, booking task type, update symptoms task type, input task type, share task type, and any definable patient-specific task type.

In some implementations, said step of defining a workflow per treatment plan comprises a further step of outputting treatment plan and nodes associated with said treatment plan.

In some implementations, said step of receiving data items relating to symptoms and patient's context, from an associated node, and receiving data items relating to measurements, from an associated node further comprises a step of receiving data items relating to symptoms and receiving data items relating to measurements, each of the data items being received as method input, user input, doctor input, patient input, or a node input.

In some implementations, said step of receiving data items relating to symptoms and patient's context, from an associated node, and receiving data items relating to measurements, from an associated node, comprises a further step of providing fields for receiving data items relating to symptoms and fields for receiving data items relating to measurements, each of said fields being communicably coupled with at least a pre-configured comparator to check if said data item input is within an acceptable range.

In some implementations, said step of receiving data items relating to symptoms and patient's context, from an associated node, and receiving data items relating to measurements, from an associated node, comprises a further step of providing fields for receiving data items relating to symptoms and fields for receiving data items relating to measurements, each of said fields being communicably coupled with at least a pre-configured comparator to check if said data item input is within an acceptable range, characterized in that, said range being a user-defined range.

In some implementations, said step of receiving data items relating to symptoms and patient's context, from an associated node, and receiving data items relating to measurements, from an associated node, comprises a further step of providing fields for receiving data items relating to symptoms and fields for receiving data items relating to measurements, each of said fields being communicably coupled with at least a pre-configured comparator to check if said data item input is within an acceptable range, characterized in that, said range being a method-defined range.

In some implementations, said step of receiving data items relating to symptoms and patient's context, from an associated node, and receiving data items relating to measurements, from an associated node, comprises a further step of providing fields for receiving data items relating to symptoms and fields for receiving data items relating to measurements, each of said fields being communicably coupled with at least a pre-configured comparator to check if said data item input is within an acceptable range, characterized in that, said range being a context-aware-defined range.

In some implementations, said step of receiving data items relating to symptoms and patient's context, from an associated node, and receiving data items relating to measurements, from an associated node, comprises a further step of providing fields for receiving data items relating to symptoms and fields for receiving data items relating to measurements, each of said fields being communicably coupled with at least a pre-configured comparator to check if said data item input is within an acceptable range, characterized in that, said range being a personalized range.

In some implementations, said step of receiving data items relating to symptoms, from an associated node, and receiving data items relating to measurements, from an associated node, comprises a further step of receiving outputs pertaining to measurements from a lab node, a wearable device node, and a diagnostics node.

In some implementations, said step of receiving data items relating to symptoms, from an associated node, and receiving data items relating to measurements, from an associated node, comprises a further step of receiving outputs pertaining to symptoms from a patient node and a care giver node.

In some implementations, said step of receiving data items relating to symptoms, from an associated node, and receiving data items relating to measurements, from an associated node, comprises a further step of receiving outputs pertaining to symptoms from a patient node and a care giver node, characterized in that, said outputs being weighted scores.

In some implementations, said step of receiving data items relating to symptoms, from an associated node, and receiving data items relating to measurements, from an associated node, comprises a further step of receiving outputs pertaining to symptoms from a patient node and a care giver node, characterized in that, said outputs being context-aware weighted scores.

In some implementations, said determined context is used in weight assignment or management for a contextual bias so as to perform a function selected from a group of functions consisting of change ranges for symptoms and measurements tracker, change selectable inputs for symptoms and measurements tracker, change associated content items, change actionable tasks associated.

In some implementations, said method comprises a step of storing content items. The method comprises at least a further step of storing interconnection relationships between content items.

In some implementations, said determined context is used to derive at least a parameter, said parameter being configured to change data of content item. The determined context is used to derive at least a parameter, said parameter being configured to change or manage weight of an actionable task. The determined context is used to derive at least a parameter, said parameter being configured to change or manage weight of an actionable task interconnections between content items. The determined context is used to derive at least a parameter, each of said derived parameters being used to map the parameters to an actionable task. The determined context is used to derive at least a parameter, each of said derived parameters being used to map the parameters to a node.

In some implementations, said determined context is used to derive at least a parameter, each of said derived parameters being used to map the parameters to an actionable task, said actionable task being selected from a group of actionable tasks, which is prepopulated in said method, said group comprising steps pertaining to: A) conducting comparisons to check output correlative. to a currently replaceable content item with a predictive output of a replacement content item along with output data from corresponding systems and measurements tracker so as to determine if the replacement content item if substituted in the treatment plan provides for an acceptable output data from the corresponding systems and measurements tracker. B) Conducting comparisons to check output correlative to a currently replaceable interconnection with a predictive output of a replacement interconnection along with output data from corresponding systems and measurements tracker so as to determine if the replacement interconnection if substituted in the treatment plan provides for an acceptable output data from the corresponding systems and measurements tracker.

In some implementations, said determined context is used to derive at least a parameter, each of said derived, parameters being used by at least a mapping mechanism to map the parameters to an actionable task, each of the at least a derived parameter comprises a weight and an actionable task associated with it, which actionable task selected from a group of actionable tasks, said group comprising: A) updating of content items from a content item database, based on the parameter and associated weight; B) addition of content items from a content item database, based on the parameter and associated weight; C) defining interconnections between content items from an interconnection database, based on the parameter and associated weight; D) updating interconnections between content items from an interconnection database, based on the parameter and associated weight.

In some implementations, said nodes are distributed in a connected environment, with said node server communicating with each of nodes.

In some implementations, said step of defining at least a node further comprises a step of prompting a user at a node to compulsorily provide a feedback in response to a task assigned to said node.

In some implementations, said step of defining at least a node further comprises a step of prompting a user at a node to compulsorily provide a feedback in response to a task assigned to said node, characterized in that, said compulsory feedback being a time-constrained compulsory feedback.

In some implementations, said step of defining at least a node further comprises a step of prompting a user at a node to compulsorily provide a feedback in response to a task assigned to said node, characterized in that, said compulsory feedback being communicably coupled with said step of receiving data items relating to symptoms, from an associated node, and receiving data items relating to measurements, from an associated node, in order to derive feedback.

In some implementations, said step of defining at least a node further comprises a step of prompting a user at a node to voluntarily provide a feedback in response to a task assigned to said node.

In some implementations, said step of defining at least a node further comprises a step of prompting a user at a node to compulsorily provide a feedback in response to a task assigned to said node, characterized in that, said voluntary feedback being a time constrained voluntary feedback.

In some implementations, said step of defining at least a node further comprises a step of prompting a user at a node to compulsorily provide a feedback in response to a task assigned to said node, characterized in that, said voluntary feedback being communicably coupled with said step of receiving data items relating to symptoms, from an associated node, and •receiving data items relating to measurements, from an associated node, in order to derive feedback.

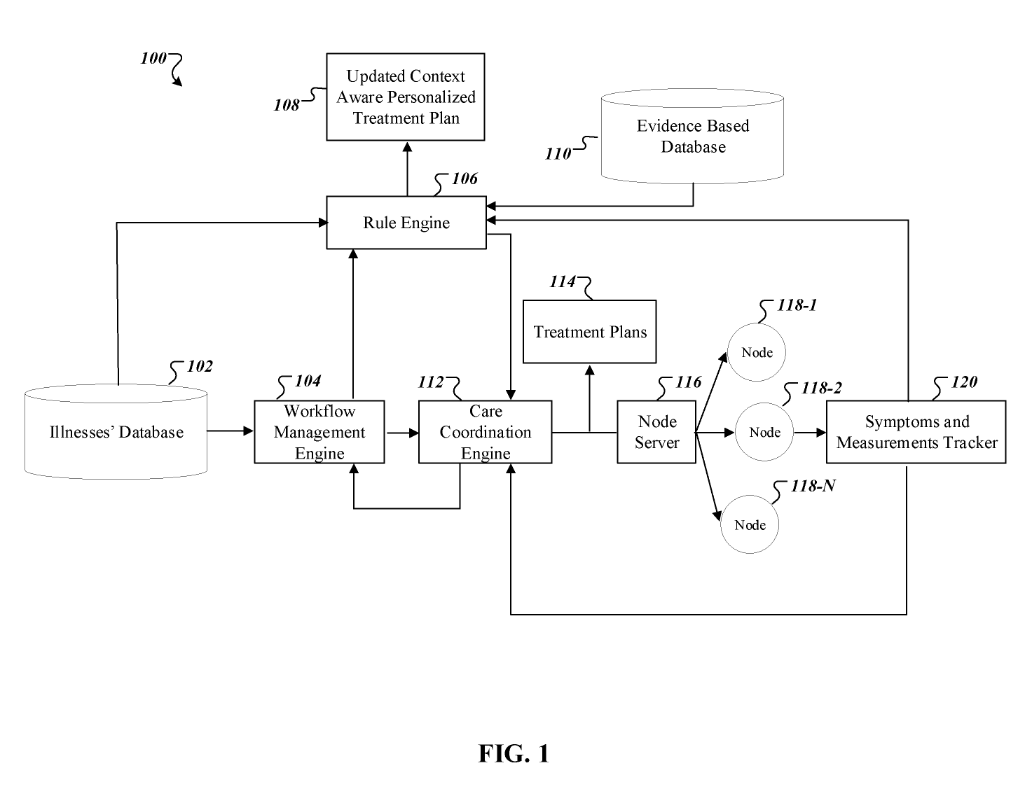

FIG. 1 illustrates a block diagram of the personalized treatment management system 100. The personalized treatment management system 100 includes an illnesses' database 102, a workflow management engine 104, a rule engine 106, and updated context aware personalized treatment plan 108, an evidence based database, a care coordination engine 112, treatment plans 114, a node server 116, node 1 118-1 through node N 118-N, and symptoms and measurement tracker 120.

In some implementations, the illnesses' database 102 includes a list of one or more illnesses accessible by a doctor. For instance, each listed illness comprises a content item configured and identified by an identifier. Additionally, each listed illness may be pre-assigned weights (or a content item). Alternatively, the illnesses' database 102 may communicable co-operate with a dynamic weight assignment mechanism in order to assign weights to an illness based on pre-defined rules.

In some implementations, the rule engine 106 may define and embed these pre-defined rules. The rules may correspond to a context item, where the context item includes demographic, time, location, epidemic status, genomic data of a patient, patient history, genetic sequence of a patient, and similar patient data. In applicable scenario, a doctor adapted to use the personalized treatment management system 100 is able to select an illness from the illnesses' database 102. For example, a doctor may select an illness such as a cold from the illnesses' database 102. In response to the doctor selecting an illness from the illnesses' database 102, a first populating mechanism 202 activates. The activation of the first populating mechanism 202 prompts further actions or populates further fields of activating certain elements of the personalized treatment management system 100 for the doctor.

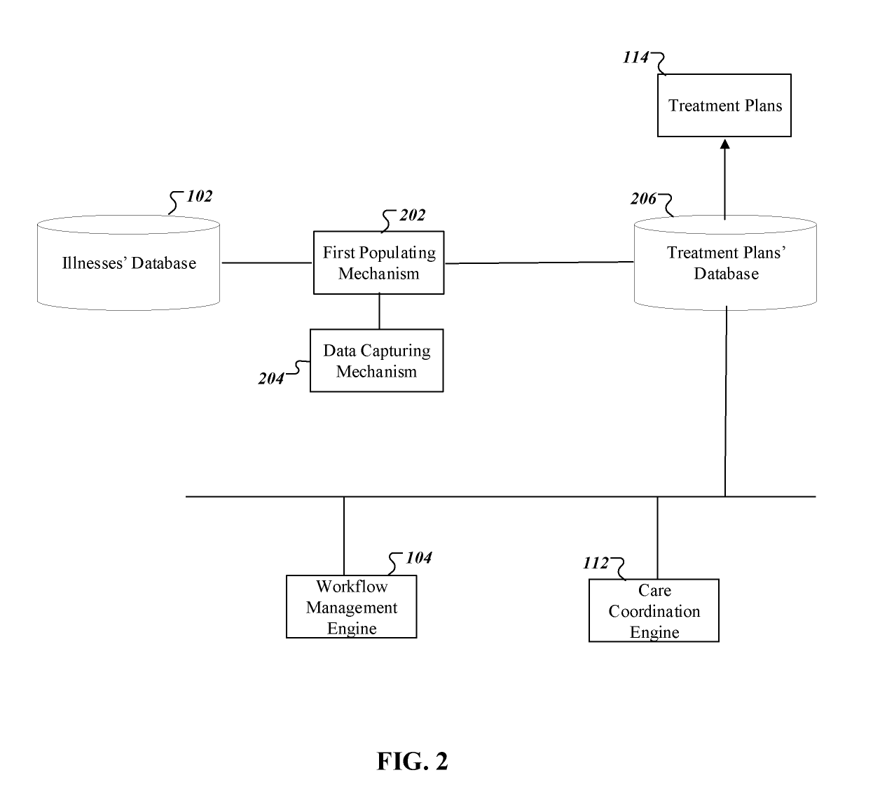

FIG. 2 illustrates another block diagram of the personalized treatment management system 200. In some implementations, the personalized treatment management system 200 includes an illnesses' database 102, a first populating mechanism 202, a data capturing mechanism 204, a treatment plans' database 206, treatment plans 114, workflow management engine 114, and a care coordination engine 112.

In some implementations, the personalized treatment management system 200 includes a context determination mechanism. The context determination mechanism is configured to determine a context in order to provide a contextual bias to a treatment plan in order to effect change in rules of the rule engine 106. Additionally, the context determination mechanism is configured to provide a context input to the rule engine 106.

In some implementations, the personalized treatment management system 200 includes a treatment plans' database 206. The treatment plans' database 206 is configured to include one or more treatment plans 114 corresponding to each listed illness or content item from the illnesses' database 102. For example, the treatment plans' database 206 can provide a treatment plan 114 of ADVIL for an individual with a headache as defined in the illnesses' database 102. Additionally, a treatment plan 114 can be defined as a medical protocol that includes a compilation of successful actions of medical practitioners corresponding to an illness. The treatment plan 114 allows one, such as a doctor, to achieve the same success of an illness on patients by following the steps of the medical protocol. For example, treatment protocols of treatment plans are based on evidence based medicine.

In some implementations, a treatment plan 114 can be defined as a set of IF THEN rules and incremental steps which start defining a condition and end with providing at least a next step ion arriving at a goal relating to the condition. Each of these steps can be stored in content items in a database, such as the treatment plans' database 206. Correlation between the steps is primarily system-defined. Correlation between the steps is additionally user-defined. Both of these correlations include interconnections between various steps in a care plan, when the plan depends on if/else/then use cases. For example, the care plan can be for treating sepsis for a diabetic patient. The interconnections of the correlations are stored in a separate database, such as the node server 116 or the evidence based database 110.

In some implementations, the treatment plan 114 includes data items. The data items include procedure performed data items, further procedure data items, medications' data items, diet data items, exercise data items, lab related data items, reports' data items, payments' data items, recommendations data items, referrals' data items, follow-ups' data items, notes' data items and the like.

In some implementations, each content item of a treatment plan 114 stored in the treatment plans' database 206 is configured to corresponding with an actionable task. For instance, the actionable task may be a null value. The actionable task me be linked to a node, such as node 118-1, defined in an environment and provided to a node server 116. For example, the nodes 118-1 through 118-N may be a care team. In one example, the actionable task may be a note or a hyperlink. The note or the hyperlink with the text or multimedia content. The actionable task may be a goal defined as by a doctor. The actionable task may be summaries or descriptions relating to treatment plans.

In some implementations, these plans may be doctor specific templates, illness specific templates, specialty specific illness, combinations, or the like. Typically, these plans include predefined protocols, steps, workflows, and methodologies per illness. A networked system of these content items, each content item forming a step is pre-defined. For each illness, a first level of interconnections between the content items is pre-defined. A series of such connections interconnect a series of content items across various databases in order to form a pre-defined network of steps (which are content items with actionable tasks) per illness or a condition. This first level of interconnections are defined and are standard treatment plans (pre-defined templates of treatment plans which will be tweaked later, based on additional content items and weights associated with them, which content items comprises illness data, hospital related contextual data, patient related contextual data, doctor related contextual data, finance related contextual data, location related contextual data, time related contextual data, genomic sequence data, genetic sequence data). For instance, these standard protocols may be utilized to determine an illness of a patient utilizing tests, iteratively and/or recursively, using the personalized management treatment system 100. As a results, the illness may then be selected from the illnesses' database 102.

In some implementations, a rule engine 106 is configured to determine rules that are configured to determine the following items: (i) updating of content items, (ii) adding of content items, (iii) defining interconnections between content items, (iv) updating interconnections between content items, and (v) rules relating to associating nodes per content item. In some implementations, the rule engine 106 receives inputs from the illnesses' database 102, the workflow management engine 104, the evidence based database 110, and the symptoms and measurements tracker 120.

In some implementations, a doctor or another user of the personalized treatment management system 100 can build databases and correlate between the built databases relating to the databases' content items and corresponding interconnections in order to achieve a set of doctor-defined IF-THEN rules. The IF-THEN rules start from defining a condition and end with providing at least a next step in arriving at a goal relating to a condition. As a result, a treatment plan 114 is defined.

In some implementations, a doctor may check whether a pre-defined treatment plan initially works for a patient. In response to the doctor determining the pre-defined treatment plan does not work, the personalized treatment management system 100 provides a tweaked treatment plan which includes at least a check identifier. For instance, the check identifier may be at least a subjective check such as a symptoms checker or at least an objective such as a measurements check. For instance, ranges for the symptoms checker and the measurements checker is contextual and personalized.

In some implementations, a symptoms and measurement tracker 120 is utilized to record, analyze, and transmit data related to the check identifier corresponding to the symptoms checker and the measurements checker, which is further explained in this specification.

In some implementations, the personalized treatment management system 100 includes methodology(ies) or flowchart(s) or guideline(s) for treating an illness. For instance, these protocols include guidelines or pointers for step of an illness starting from examination to prognosis and including the intermittent steps of diagnosis, treatment plan, and prescription. Each template may comprise a variable content item or a customizable content item which is specific to a patient depending upon pre-defined parameters derived from a context such as history of a patient, demographics of a patient, lifestyle of a patient, genetic sequence of a patient, gene pool of a patient, genomic data of a patient, allergies of a patient, exodus data, digital phenotypic data, case studies, textbook matter, journal content, and such other patient-specific dynamics.

In some implementations, a doctor follows a particular treatment plan 114 for an illness. Alternatively, since these treatment plans can be too generalized, therefore, a doctor chooses to modify these treatment plans according to experience. For instance, these experiences may be standardized by articulating parameters that do affect and/or should affect the treatment plans and that do not affect and/or should not affect the treatment plans 114. As a result, these parameters provide an updated customized treatment plan or updated context aware personalized treatment plan 108. Furthermore, this present disclosure is configured to receive feedback from a multiplicity of sources, in real-time or delayed-time, continuously or over discrete time-intervals in order to provide an update customized weighted treatment plan 108. Additionally, this disclosure is configured to apply a context-relevant weight to content items in a treatment plan, thereby providing an updated customized weighted context aware treatment plan 108.

In some implementations, the personalized treatment management system 200 includes a data capturing mechanism 204. The data capturing mechanism 204 is configured to capture data of a patient per illness as per configured fields in a template. The data capturing mechanism 204 converts the captured patient data into content items, which correlate with fields of the treatment plan 114. For example, the conversion could convert data submitted by a patient as text to a risk or weight score in the backend using one or more medical score engines. In another example, a patient can input how he or she is feeling, such as behavior, and these inputs can be converted into a particular weighted value that is fed to a treatment plan at the backend. With the captured patient data, the data can be intelligently applied or used by other embodiments, means, steps, flowcharts, methodologies, and mechanisms of the system and method of the personalized treatment management system 100. For instance, the data capturing mechanism 204 is also configured to capture various other data items such as patient identification items, illness content data items, patient history data items, data items pertaining to illness data, genetic sequence data items, genomic data items, and the like data items essential for treating an illness of a patient, in terms with treatment plans 114. Further, data items relating to devices or implants may also be captured and correlated with patient-specific data and/or illness-specific data. Additionally, these data items are used to assign weights to rules of the rule engine 106.

In some implementations, the personalized treatment management system 100 includes a content item database and an interconnection database. For each context, at least a parameter is derived. For instance, the parameters changes the probability or weight defined of an actionable task in the illnesses' database 102. Additionally, the parameters changes the interconnections between each of the content items. A mapping mechanism in the personalized treatment management system 100 maps the derived parameters to an actionable task. This actionable task is selected from a group of actionable tasks, which may be pre-populated in the personalized treatment management system 100. The group of actionable tasks includes a pre-instructed comparators configured to conduct comparisons to check output correlative to a currently replaceable content item with a predictive output of a replacement content item along with output data from corresponding systems and measurements tracker so as to determine if the replacement content item is substituted in the treatment plan 114 provides for an acceptable output data from the corresponding systems and measurement tracker. Additionally, the group of actionable tasks include pre-instructed comparators configured to comparisons to check output correlative to a currently replaceable interconnection with a predictive output of a replacement interconnection along with output data from corresponding systems and measurements tracker so as to determine if the replace interconnection is substituted in the treatment plan and provides for an acceptable output data from the corresponding systems and measurement tracker.

In some implementations, each of the at least derived parameter comprises a weight and an actionable task associated with the parameter. The actionable task includes (i) updating of content items from the content item database, based on the parameter and associated weight; (ii) adding content items from the content item database, based on the parameter and associated weight; (iv) defining interconnections between content items from the interconnection database, based on the parameter and associated weight; and, (v) updating interconnections between content items from the interconnection (between content items) database, based on the parameter and associated weight.

In some implementations, the personalized management treatment system 100 includes a visit summary template. The visit summary template is configured to output data items associated with a visit between a patient and any of the nodes. For instance, nodes 118-1 through 118-N. Data items from illnesses' database 102 are fed in to the visit summary template based on patient output of the visit. These data items correlate with treatment plan 114, a procedure performed, and further actions such as medications, diet, exercise, lab tests, reports, payments, recommendations, referrals, follow-ups, and notes which are parsed to extract content (i.e. data items) pertinent to predefined fields in the treatment plans. For example, the data items may be parsed using techniques such as natural language processing. These data items are further provided to a care coordination engine 112, which will aid in receiving iterative and /or recursive feedback for being fed into treatment plan(s) 114. Additionally, these data items are used to assign weights to rules of a rule engine 106.

In some implementations, the personalized management treatment system 100 provides an evidence-based database 110. The evidence based database 110 is configured to store content items relating to evidence based medicine, such as data from journals, clinical trials, case studies, and the like. These data items correlate with fields of the treatment plan(s) 114. Additionally, these data items are used to assign weights to rules of the rule engine 106. Data from these sources is structured, tagged, meta-tagged, correlated with at least one of illnesses' data items, medications' data items, data items pertaining to clinical data, data items pertaining to pathological data, data items pertaining to genomic data, data items pertaining to genetic data, time related data items, location related data items, and the like data items and are stored.

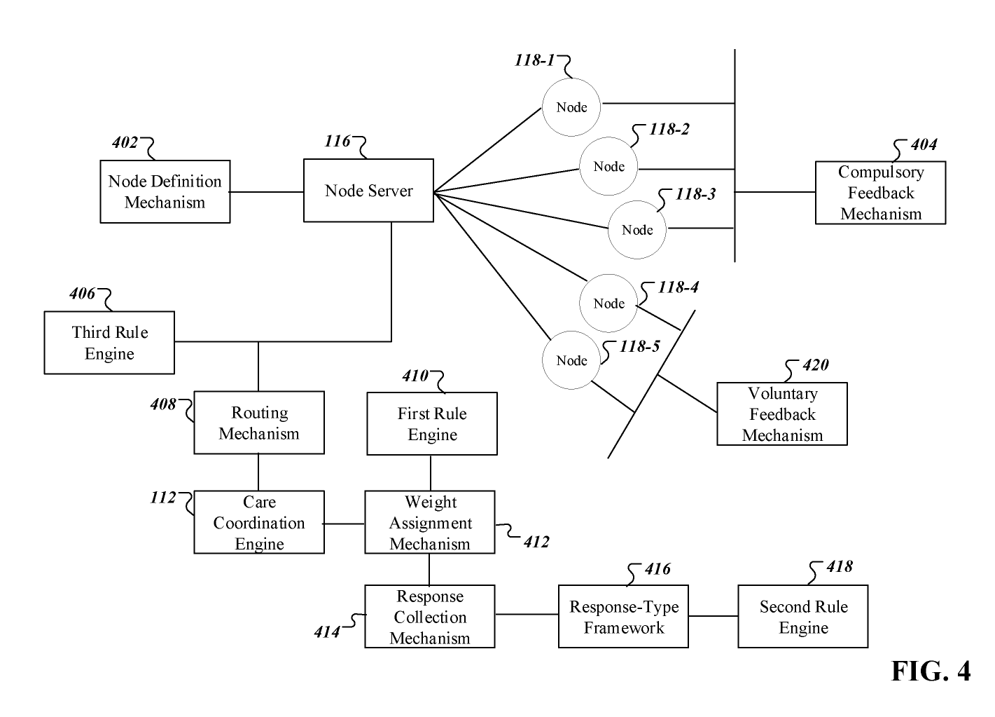

In some implementations, the personalized management treatment system 100 includes a node definition mechanism 402, as illustrated in FIG. 4, configured to define a plurality of nodes. These nodes are distributed in a connected environment utilized by the personalized management treatment system 100. A node server 116 communicates with each of these nodes. For instance, the nodes may be nodes 118-1 through 118-N. For instance, the node server 116 receives instructions from the care coordination engine 112. The nodes 118-1 through 118-N may be fitted with a compulsory feedback mechanism 404. The compulsory feedback mechanism 404 requires that a user at a designated node, such as nodes 118-1 through nodes 118-3, is required to provide a feedback in response to a task assigned at the node. For example, the compulsory feedback mechanism 404 can send a survey to a patient in which the patient would have to complete compulsory questions or tasks required in the survey. This required feedback response may be within a time-frame in which the compulsory feedback needs to be recorded. Some nodes, such as nodes 118-4 and 118-5, are fitted with a voluntary feedback mechanism 420, such that a user at that node may or may not record a feedback in response to a task assigned to that node. Additionally, there may be a time-frame within which the voluntary feedback needs to be recorded. The compulsory feedback mechanism 404 is communicable coupled with the symptoms and measurement tracker 120 in order to derive feedback. Also, the voluntary feedback mechanism 420 is communicable coupled with symptoms and measurement tracker 120 in order to derive feedback. For example, the voluntary feedback mechanism 420 can track how many steps a patient traveled today. The derived feedback is then fed back to the symptoms and measurement tracker 120 to see if the patient has achieved the goals, such as steps, set for him or her.

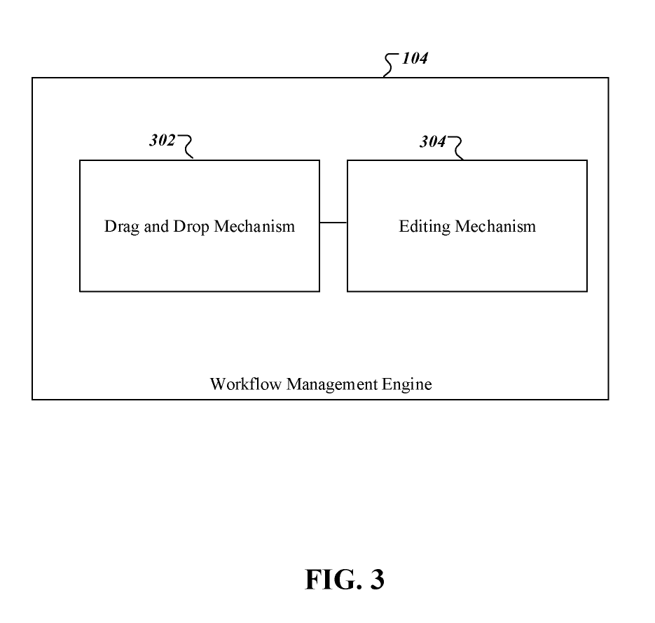

In some implementations, the workflow management engine 104 is configured to define a workflow per treatment plan. For instance, a workflow per treatment plan comprises a flowchart (interconnections) or methodology per illness along with content items (and actionable tasks). This flowchart is comprised of various steps/modules, which steps/modules are content items with actionable tasks associated with the content items. Typically, a doctor is authorized to modify these flowcharts in accordance with pre-defined rules. Additionally, the personalized management treatment system 100 is configured to modify these workflows using the rule engine 106. These pre-defined rules may be selected from a group of rules comprising contexts pertaining to illness data, patient data, historical data, empirical data, statistical data, third party data, medication data, and/or the like. Further, as illustrated in FIG. 3, the workflow management engine 104 comprises an editing mechanism 304 configured to edit, tweak, customize, or change workflows per illness. In addition, the editing mechanism 304 may be characterized by a drag and drop mechanism 302 which enables various content items and interconnections of a workflow template to be dragged and dropped as per doctor's choice or the system's and method's choice and in accordance with pre-defined system-defined rules, in order to create a customized workflow per patient per illness i.e. a customized treatment plan. Thus, these mechanisms aid a doctor to determine a practice a different treatment plan than what is standardly defined.

Additionally, the personalized management treatment system 100 is configured to modify the workflow through the rule engine 106. For instance, the output of the workflow management engine 104 is passed to the care coordination engine 112. The output of the workflow management engine 104 includes content items of a treatment plan, e.g., goals related to content items which tie up with content items related to the treatment plan, nodes (such as, care teams), associated with treatment plans and tied up with the node server 116, visit summary related content items related to the treatment plan, and the like.

FIG. 3 illustrates a block diagram of the workflow management engine 104. In some implementations, the workflow management engine 104 includes a drag and drop mechanism 302 and an editing mechanism 304.

In some implementations, the personalized management treatment system 100 provides a symptoms and measurement tracker 120. While the final objective of this invention is to treat a patient, it is achieved by configuring the symptoms and measurement tracker 120 to be configured to comprise fields for receive data items relating to symptoms, through a symptoms data input mechanism, and fields for receiving data items relating to measurements, through a measurements data input mechanism, each of the data items being received as system input, user input, doctor input, patient input, or the like. For instance, some of the fields are communicably coupled with at least a pre-configured comparator to check if the data item input in the field is within an acceptable range.

In some implementations, the acceptable range is a context-aware range, which changes based on a context weight applied to some of the fields based on output from the workflow, such as from the care coordination engine 112 or output from the workflow management engine 104. In some implementations, this range may be a personalized range, which changes on a patient-specific weight applied to some of the field based on output from the care coordination engine 112 or output from the workflow management engine 104.

In some implementations, output from labs and diagnostics receives measurements as output which will be input to the workflow management engine 104. Alternatively, input from a doctor is an objective input to finally feed into symptoms and measurements tracker 120. Subjective inputs to be parsed by natural language processing to provide a weighted score to each of the input data items of symptoms and measurements tracker 120.

In some implementations, input from a patient/care-giver/care coordinator is an objective input to feed into symptoms and measurements tracker 120. Subjective inputs to be parsed by natural language processing to provide a weighted score to each of the input data items of symptoms and measurements tracker 120.

In some implementations, a context can be used in weight assignment for a contextual bias so as to perform one of the following functions: (i) change ranges for symptoms and measurements tracker 120, (ii) change selectable inputs for symptoms and measurements tracker 120, (iii) change associated content items, (iv) change actionable tasks associated with a content item, and (v) change interconnection between content items.

In some implementations, the personalized treatment manage system 100 includes a care coordination engine 112 configured to break down protocols obtained from a template from the workflow management engine 104 into intelligent and actionable tasks. The care coordination engine 112 is configured in line with protocols of a template. For example, templates, such as care plan templates, include standard templates for medicinal management, such as diabetic management or Central Auditory Processing Disorder (CAPD) management. The care coordination engine 112 identifies a particular template and further in co-ordination with data captured using the data capturing mechanism 204 from the template, uses the data of the template for conversion to intelligent and actionable tasks. Further, the care coordination engine 112 is coupled with a weight assignment mechanism 412 configured to assign weights to a defined task, intelligently.

In some implementations, a first rule engine 410 is configured to define a first set of rules to determine weights of a defined task. Further, the care coordination engine 112 is communicably coupled with a routing mechanism 408, which routes each divided task to a particular node using the node server 116. Each task is further intelligently correlated with a response collection mechanism 414. For instance, intelligently correlated requires tasks to be sent on a mobile device, for example, will automatically be sent to the mobile device. In another example, a task that needs to be alerted via an SMS message will be routed accordingly to the mobile device. Additionally, a task that needs to be completed with a measurement of weight will be automatically routed. These tasks may be routed and performed by a third rule engine 406, as further described below. The response collection mechanism 414 decides whether or not a response is to be elicited/recorded from a user of the node, such as node 118-2.

In some implementations, the response collection mechanism 416, in turn, also invokes a response-type framework 416, which assigns what type of feedback is to be recorded. Exemplary embodiments of responses-types may include dosages, affirmatives and negatives, text data, and the like. A second rule engine 418 is configured to define a second set of rules to determine the manner in which the response collection mechanism is to execute. For instance, these second set of rules consider parameters relating to the type and nature or task, rank and/or weight of task. Additionally, a third rule engine 406 is configured to define a third set of rules to determine where the task is to be routed. For instance, these third set of rules consider parameters template data, metadata, or the like.

In some implementations, tasks can also include notifications and follow-ups. Therefore, there may be automated notifications and follow-ups in line with rules and nodes, as defined by the care coordination engine 112.

In some implementations, the care coordination engine 112 is also configured to provide simple feedback in terms of whether treatment plans 114 or changes in treatment plans or portions of treatment plans have worked or need further change. Feedback aids in standard rising treatment plans and workflows, thereof—i.e. in measuring and intervening.

FIG. 4 illustrates a block diagram of a care coordination system. The care coordination system includes a node definition mechanism 402, a node server 116, a node 118-1 through 118-5, a compulsory feedback mechanism 404, a third rule engine 406, a routing mechanism 408, a first rule engine 410, a care coordination engine 112, a weight assignment mechanism 412, a response collection mechanism 414, a response-type framework 416, a second rule engine 418, and a voluntary feedback mechanism 420.

In some implementations, the care coordination engine 112 includes a treatment plan 114 as an input. Using the system and method of this present disclosure, the output may be a tweaked treatment plan which is further sent as feedback to the care coordination engine 112. For instance, natural language processing may be utilized to parse data from the tweaked treatment plan in order to provide actionable tasks to doctors. For example, the actionable tasks may include parsing through the discharge summary or visit summary. These tasks may be parsing through NLP structure and produce formed tasks. For instance, the formed tasks may include measurement task type, score task type, wearable input task type, reminder task type, booking task type, update symptoms task type, input task type, share task type. The formed tasks can be mapped to different treatment plan details and each task is mapped to an activity for each treatment protocol or plan, a care coordinate does the pre-mapping for relationships to be formed. The mapping is based on pre-defined weight assignment at the backend.

In some implementations, output from the workflow management engine 104 may include goal related content items which tie up with content items related to the treatment plan 114, nodes (care team) associated with a treatment plan 114 and tied up with a node server 116, visit summary related content items related to the treatment plan 114, and the like. This information is provided to the care coordination engine 112. Each of these inputs will convert to actionable tasks.

In some implementations, each task needs to be routed to a specific node of the care team. The mapping of the routing based on various relationships of input items. Multiple care providers can communicate to the personalized management treatment system 100.

In some implementations, output from nodes 118-1 through 118-N, such as the information systems, nursing homes, radiology's (appointments, results, pharmacy queries, pharmacy refill request, feedback from care team, feedback from patient), is provided to the care coordination engine 112. In some implementations, the output from the symptoms and measurement tracker 120 is provided to the care coordination engine 112.

In some implementation, an iteration mechanism is configured to iteratively learn from the responses.

In some implementations, the output of the personalized management treatment system 100 and the symptoms and measurements tracker 120 includes a list of symptoms and measurements of a patient. The output may be marked in a range of data items. Additionally, the personalized management treatment system 100 is configured to receive inputs from a doctor and/or a patient for each of these subjective and objective scores. Based on this input, a doctor and/or a patient is able to feed and provide input data to the symptoms and measurements tracker 120, which determines if the objective that the patient being treated is met or not with the doctor.

In some implementations, the system can intelligently check and compare received measurements from the doctor with standard or context-aware measurements to determine if the patient is acceptably treated. Further, the personalized management treatment system 100 can receive input from a doctor and/or patient relating to symptoms in a weighted manner so as to determine if the patient is acceptably treated or not. The first set of rules for acceptable treatment are defined in a manner, which correlate with symptoms. The second set of rules for acceptable treatment are defined in a manner, which correlate with measurements.

In some implementations, the personalized treatment management system 100 includes objectives that relate to measuring data items from symptoms and measurements tracker 120 relative to change in treatment protocols. Any change in treatment protocols take place in the workflow management engine 104. The workflow management engine 104 includes editing, dragging and dropping, feed from the care coordination engine 112.

In some implementations, a user is able to correlate existing treatment protocols vis-á-vis changed treatment protocols. One of the plurality of parameters includes a correlation factor. In addition, the plurality of parameters comprise illness data, hospital related contextual data, patient related contextual data, doctor related contextual data, finance related contextual data, location related contextual data, time related contextual data, genomic sequence data, genetic sequence data, and the like. This enables the personalized management treatment system 100 to produce more dynamically correlative evidence.

As a result, a user, can therefore record these tweaked or changed personalized treatment protocols as standardized treatment protocols which can further be used by the workflow management engine 104 and care coordination engine 112.

In one applicable example, one of the nodes, such as node 118-2, may be an insurance company, which keeps a tab on the tasks allocated and responses to the tasks. If it is determined that a particular task in the protocol or the template has not been followed due to fault of a patient, the insurance subscriptions of the patient may be affected. If it is determined that a particular task in the protocol of the template has not been followed due to fault of a doctor, the malpractice insurance subscriptions of the doctor may be affected.

In some implementations, the nodes may be a pharmacy, which received automated ordering, or filling of medication based on data captured in the template in correspondence with received responses per patient. As a result, each node of a healthcare ecosystem connects to the healthcare ecosystem in an authenticated and responsive manner.

The data, in each of the components, means, modules, mechanisms, units, devices of the system and method may be encrypted and suitably decrypted when required.

The systems described herein can be made accessible through a portal or an interface which is a part of, or may be connected to, an internal network or an external network, such as the Internet or any similar portal. The portals or interfaces are accessed by one or more of users through an electronic device, whereby the user may send and receive data to the portal or interface which gets stored in at least one memory device or at least one data storage device or at least one server, and utilizes at least one processing unit. •The portal or interface in combination with one or more of memory device, data storage device, processing unit and serves, form an embedded computing setup, and may be used by, or used in, one or more of a non-transitory, computer readable medium. In at least one embodiment, the embedded computing setup and optionally one or more of a non-transitory, computer readable medium, in relation with, and in combination with the said portal or interface forms one of the systems of the invention. Typical examples of a portal or interface may be selected from but is not limited to a website, an executable software program or a software application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude or rule out the presence or addition of one or more other features, integers, steps, operations, elements, components, and/or groups thereof.

In some implementations, the personalized management treatment system 100 allows for customization of treatment plans and corresponding workflows per patient per illness. Further, it provides conversion of workflows to intelligent and actionable tasks and notification which allows for tracking, feedback, planning, and quality care.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving captured patient data in a template format with one or more fields;
receiving a selection of a likelihood of an illness corresponding to a patient;
determining a treatment plan for the patient using captured patient data, wherein the treatment plan comprises content items with actionable tasks and interconnection between the content items that provide treatment steps based on the illness of the patient; and
determining a workflow for the determined treatment plan for the patient.

2. The computer-implemented method of claim 1, further comprising:
assigning weights to the illness based on pre-defined and self-learning rules utilizing a rule engine; and
determining embedding rules utilized by the rule engine pertaining to a context item, wherein the context item comprises demographic, time, location, epidemic status, genomic data, patient history, and genetic sequence of the patient.

3. The computer-implemented method of claim 2, wherein the embedding rules comprise rules selected from a group of rules comprising contexts pertaining to illness data, data of the patient, historical data, empirical data, statistical data, third party data, medication data, and other data related to the patient.

4. The computer-implemented method of claim 3, further comprising:
in response to determining the treatment plan is not effective for curing the illness of the patient, determining a tweaked treatment plan to provide to the patient that comprises a symptoms checker and a measurements checker.

5. The computer-implemented method of claim 4, wherein determining the tweaked treatment plan to provide to the patient further comprises:
parsing data from the tweaked treatment plan to provide the actionable tasks to implement the tweaked treatment plan; and
mapping the actionable tasks to one or more different tweaked treatment plan details.

6. The computer-implemented method of claim 5, wherein the actionable tasks comprise a measurement task type, a score task type, a wearable input task type, a reminder task type, booking task type, update symptoms, task type, input task type, share task type, and a patient-specific task type.

7. A system comprising:
one or more computers and one or more storage devices storing instructions that are operable, when executed by the one or more computers, to cause the one or more computers to perform operations comprising:
receiving captured patient data in a template format with one or more fields;
receiving a selection of a likelihood of an illness corresponding to a patient;
determining a treatment plan for the patient using captured patient data, wherein the treatment plan comprises content items with actionable tasks and interconnection between the content items that provide treatment steps based on the illness of the patient; and
determining a workflow for the determined treatment plan for the patient.

8. The system of claim 7, further comprising:
assigning weights to the illness based on pre-defined and self-learning rules utilizing a rule engine; and
determining embedding rules utilized by the rule engine pertaining to a context item, wherein the context item comprises demographic, time, location, epidemic status, genomic data, patient history, and genetic sequence of the patient.

9. The system of claim 8, wherein the embedding rules comprise rules selected from a group of rules comprising contexts pertaining to illness data, data of the patient, historical data, empirical data, statistical data, third party data, medication data, and other data related to the patient.

10. The system of claim 9, further comprising:
in response to determining the treatment plan is not effective for curing the illness of the patient, determining a tweaked treatment plan to provide to the patient that comprises a symptoms checker and a measurements checker.

11. The system of claim 10, wherein determining the tweaked treatment plan to provide to the patient further comprises:
parsing data from the tweaked treatment plan to provide the actionable tasks to implement the tweaked treatment plan; and
mapping the actionable tasks to one or more different tweaked treatment plan details.

12. The system of claim 11, wherein the actionable tasks comprise a measurement task type, a score task type, a wearable input task type, a reminder task type, booking task type, update symptoms, task type, input task type, share task type, and a patient-specific task type.

13. A non-transitory computer-readable medium storing software comprising instructions executable by one or more computers which, upon such execution, cause the one or more computers to perform operations comprising:
receiving captured patient data in a template format with one or more fields;
receiving a selection of a likelihood of an illness corresponding to a patient;
determining a treatment plan for the patient using captured patient data, wherein the treatment plan comprises content items with actionable tasks and interconnection between the content items that provide treatment steps based on the illness of the patient; and
determining a workflow for the determined treatment plan for the patient.

14. The computer-readable medium of claim 13, further comprising:
assigning weights to the illness based on pre-defined and self-learning rules utilizing a rule engine; and
determining embedding rules utilized by the rule engine pertaining to a context item, wherein the context item comprises demographic, time, location, epidemic status, genomic data, patient history, and genetic sequence of the patient.

15. The computer-readable medium of claim 14, wherein the embedding rules comprise rules selected from a group of rules comprising contexts pertaining to illness data, data of the patient, historical data, empirical data, statistical data, third party data, medication data, and other data related to the patient.

16. The computer-readable medium of claim 15, further comprising:
in response to determining the treatment plan is not effective for curing the illness of the patient, determining a tweaked treatment plan to provide to the patient that comprises a symptoms checker and a measurements checker.

17. The computer-readable medium of claim 16, wherein determining the tweaked treatment plan to provide to the patient further comprises:
parsing data from the tweaked treatment plan to provide the actionable tasks to implement the tweaked treatment plan; and
mapping the actionable tasks to one or more different tweaked treatment plan details.

18. The computer-readable medium of claim 17, wherein the actionable tasks comprise a measurement task type, a score task type, a wearable input task type, a reminder task type, booking task type, update symptoms, task type, input task type, share task type, and a patient-specific task type.

19. The computer-readable medium of claim 14, further comprising:
receiving modifications to the workflow of the determined treatment plan using the pre-defined and self-learning rules of the rule engine.

20. The computer-readable medium of claim 13, further comprising:
determining whether values of the content items exist within an acceptable range, wherein the acceptable range changes based on a context weight applied to the workflow of the patient.
